(19) United States
(12) Patent Application Publication
(10) Pub. No.: US 2004/0070579 A1
(43) Pub. Date: Apr. 15, 2004

(54) Display device

(76) Inventor: Hiroshi Kurihara, Mobara (JP)

Correspondence Address: REED SMITH LLP, Suite 1400, 3110 Fairview Park Drive, Falls Church, VA, 22042, US

(21) Appl. No.: 10/649,680

(22) Filed: Aug. 28, 2003

(30) Foreign Application Priority Data
Sep. 2, 2002 (JP) 2002-256573

(51) Int. Cl. G09G 5/00

(52) U.S. Cl. 345/204

(57) ABSTRACT

In a display device comprising a plurality of gate signal lines juxtaposed on a substrate surface, a plurality of drain signal lines juxtaposed transverse to the plurality of gate signal lines, a plurality of pixels arranged two-dimensionally on the substrate surface, and a video signal driving circuit inputting a signal to each of the plurality of drain signal lines at one end side thereof, wherein each of the plurality of pixels has a switching element controlled by a scanning signal transmitted through one of the plurality of gate signal lines and indicates brightness in accordance with the signal supplied from one of the plurality of drain signal lines through the switching element, the present invention amplifies the signal to raise driving performance of a first pixel belonging to one group of the plurality of pixels each of which receives the signal from the one of the plurality of drain signal lines higher than that of a second pixel belonging to the one group of the plurality of pixels and located closer to the video signal driving circuit than the first pixel, and suppresses unevenness of brightness appearing in a pixel region formed on the substrate surface by the plurality of pixels.

### BACKGROUND OF THE INVENTION

1. Field of the Invention

The present invention relates to an image display device such as a liquid crystal display device or an organic EL (Electro Luminescence) display device which performs an image display by active matrix driving.

2. Description of the Related Art

A liquid crystal display device which performs an image display by active matrix driving is described in Japanese Unexamined Patent Publication 1995-098575 (and corresponding U.S. Pat. No. 5,610,414), for example. Further, an organic EL display device which performs an image display by active matrix driving is described in Japanese Unexamined Patent Publication 1999-024606 (and corresponding European Patent Unexamined Patent Publication: EP0935229 A1), for example.

Each of these active matrix driving type display devices includes at least one substrate and a plurality of gate signal lines and a plurality of drain signal lines which respectively cross the plurality of gate signal lines are juxtaposed on the substrate. Further, on a region of a substrate surface on which the plurality of gate signal lines and the plurality of drain signal lines cross each other, a plurality of pixels are arranged in a two-dimensional manner along the juxtaposing direction of the gate signal lines and the juxtaposed direction of the drain signal lines. Each one of the plurality of pixels includes a switching element which is controlled by one of the above-mentioned plurality of gate signal lines and exhibits brightness in response to a signal supplied from one of the above-mentioned plurality of drain signal lines through the switching element. To a plurality of pixels which are formed on a liquid crystal display device, a field emission type display device or an electro luminescence display device driven by voltages, electrodes which receive the above-mentioned signals (voltage signals) from the above-mentioned switching elements are provided. In the liquid crystal display device, an electric field is applied to a liquid crystal layer which is sealed between a pair of substrates due to the electrode so as to change the optical transmissivity locally. In the field emission type display device, electrons are emitted to a fluorescent material (formed for each pixel, for example) from the electrode and hence, the fluorescent material emits light. In the electro luminescence display device driven by voltage, a voltage is applied to an EL (Electroluminescent) material layer (formed for each pixel, for example) which is sandwiched between the electrode and another electrode which faces the electrode, the EL material layer emits light.

On the other hand, in a current driving type display device which is popularly observed in the organic electro luminescence display device and in which brightness is controlled in response to an amount of charge injected to a light emitting region, a current of the above-mentioned signal supplied from one of the above-mentioned plurality of drain signal lines through the above-mentioned switching element is injected to the light emitting region (for example, EL material layer) so as to make the light emitting region emit light. Further, in a current driving type display device which is provided with a switching element for controlling the injection of charge to the light emitting region for every pixel, a charge injection amount to the light emitting region is controlled by driving the switching element for controlling the injection of charge in response to the above-mentioned signal supplied from one of the above-mentioned drain signal lines through the above-mentioned switching element.

In any one of the above-mentioned examples, a group consisting of the above-mentioned plurality of pixels are arranged along each one of the plurality of drain signal lines which extend within the substrate surface, and the respective pixels which belong to the group sequentially receive the above-mentioned signal from one of the drain signal lines corresponding to the pixels. Further, the respective pixels are arranged within the substrate surface as pixel regions each of which includes the above-mentioned switching element and the above-mentioned electrode which is connected to the switching element or the above-mentioned light emitting region which is controlled by the electrode. Each pixel region is, for example, defined as a region which is surrounded by a pair of gate signal lines out of the above-mentioned plurality of gate signal lines and a pair of drain signal lines out of the above-mentioned plurality of drain signal lines within the substrate surface.

### SUMMARY OF THE INVENTION

Along with the progress of application of the above-mentioned display device to the television or the like, there arises a demand for the further enlargement of the display area. Accordingly, there is no ways but to enlarge the area of the substrates used in the display device and hence, the above-mentioned gate signal lines and the above-mentioned drain signal lines which extend from one end to the other end must be extended or elongated far exceeding the current lengths thereof. However, along with the formation of elongated signal lines which are juxtaposed and extend within the substrate surface, there arise drawbacks. Accordingly, under the current circumstances, the large-sizing of the display device is limited.

For example, along with the elongation of the gate signal lines, due to the resistance or parasitic capacitance which is generated in the gate signal lines per se, there arises strain in waveforms of scanning signals which are supplied through the gate signal lines. In the same manner, along with the elongation of the drain signal lines, due to the resistance or parasitic capacitance which is generated in the drain signal lines per se, there arises strain in waveforms of video signals (the above-mentioned signals supplied to the pixels) which are supplied through the drain signal lines. Due to such a strain of the signal waveforms, regions which exhibit high brightness and regions which exhibit low brightness are formed whereby so-called unevenness of brightness can be observed by naked eyes.

The present invention has been made in view of such circumstances and it is an object of the present invention to provide a display device which can suppress the occurrence of the unevenness of brightness.

To explain the summary of typical inventions among the inventions disclosed in the present application, they are as follows.

<<Display Device 1>>

A first example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface; and a video signal driving circuit connected to respective one end sides of the plurality of video signal lines, wherein

(1) the plurality of pixels includes a first pixel selected by one of the scanning signal lines and a second pixel located closer to the video signal driving circuit than the first pixel and selected by another of the scanning signal lines, each of which receives a signal from one of the plurality of video signal lines sequentially in response to respective selection thereof and indicates brightness in accordance with the signal,

(2) the signal is inputted to the one of the plurality of video signal lines through amplifying means from the video signal driving circuit, and

(3) the amplifying means raises driving performance of the first pixel higher than that of the second pixel.

Preferably, the aforementioned display device 1 further comprises means for adjusting the driving performance.

<<Display Device 2>>

A second example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface; and a video signal driving circuit connected to the plurality of video signal lines respectively, wherein

(1) one of the plurality of video signal lines supplies a video signal to one and another of the plurality of pixels sequentially, in response to when respective one of the scanning signal lines selects either the one or the another of the plurality of pixels, the another of the plurality of pixels is located closer to the video signal driving circuit than the one of the plurality of pixels, and each of the one and the another of the plurality of pixels indicates brightness in accordance with the video signal supplied from the one of the plurality of video signal lines,

(2) the video signal has a voltage in accordance with a tone to be displayed, the voltage is determined by and varies in accordance with a gradation forming voltage, and

(3) the gradation forming voltage is increased higher when the video signal is supplied to the one of the plurality of pixels than when the video signal is supplied to the another of the plurality of pixels.

Preferably, the aforementioned display device 2, further comprises means for adjusting the gradation forming voltage.

<<Display Device 3>>

A third example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface, each of which has a switching element and receives a video signal from one of the plurality of video signal lines when the switching element is turned on by one of the plurality of scanning signal lines; a video signal driving circuit connected to respective ends of the plurality of video signal lines, and a scanning signal driving circuit inputting voltage signals turning on the switching elements video to the plurality of scanning signal lines respectively, wherein

(1) the voltage signal inputted to one of the plurality of scanning signal lines is higher than that inputted to another of the plurality of scanning signal lines located closer to the video signal driving circuit.

Preferably, the aforementioned display device 3, further comprises means for adjusting the voltage signal inputted to one of the plurality of scanning signal lines with reference to the voltage signal supplied to another of the plurality of scanning signal lines located further from the video signal driving circuit than the one of the plurality of scanning signal lines.

<<Display Device 4>>

A fourth example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface; and a video signal driving circuit connected to respective one end sides of the plurality of video signal lines, wherein

(1) the plurality of pixels includes a first pixel selected by one of the scanning signal lines and a second pixel located closer to the video signal driving circuit than the first pixel and selected by another of the scanning signal lines, each of which receives a signal from one of the plurality of video signal lines sequentially in response to respective selection thereof and indicates brightness in accordance with the signal, and

(2) the video signal driving circuit inputs the signal to the second pixel with larger delay than when the video signal driving circuit inputs the signal to the first pixel.

<<Display Device 5>>

A fifth example of display devices according to the present invention is applied to either one of the aforementioned display devices 1, 2, 3, and 4, wherein

(1) information on a start of frame and latch pulses corresponding to every one line of the display data are inputted to the video signal driving circuit,

(2) the display device 5 further comprises scanning line position measurement means counting the latch pulses according to an input of the information on the start of frame and outputting scanning line position information, and

(3) the scanning line position information determines whether one of the plurality of pixels is located closer to the video signal driving circuit than another of the plurality of pixels, or not.

<<Display Device 6>>

A sixth example of display devices according to the present invention is applied to either one of the aforementioned display devices 1, 2, 3, and 4, wherein

(1) the display device 6 comprises a display control circuit,

(2) display data including retrace periods between every pair of line data thereof are transmitted from the display control circuit to the video signal driving circuit,

(3) the display control circuit transmits scanning line position information related to the respective line data in each of the retrace periods, and

(4) the scanning line position information determines whether one of the plurality of pixels is located closer to the video signal driving circuit than another of the plurality of pixels, or not.

<<Display Device 7>>

A seventh example of display devices according to the present invention is applied to either one of the aforementioned display devices 1, 2, 3, and 4, wherein

(1) the display device 7 comprises a display control circuit,

(2) the display control circuit transmits pulses to the video signal driving circuit,

(3) the display control circuit comprises means for varying widths of the pulses in accordance with scanning line position information and means for reading the scanning line position information from the widths of the pulse, and

(4) the scanning line position information determines whether one of the plurality of pixels is located closer to the video signal driving circuit than another of the plurality of pixels, or not.

<<Display Device 8>>

A eighth example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface, each of which has a switching element and receives a video signal from one of the plurality of video signal lines in response to an application of a scanning signal to the switching element by one of the plurality of scanning signal lines; a video signal driving circuit connected to respective ends of the plurality of video signal lines; and a scanning signal driving circuit inputting the scanning signal to each of the plurality of scanning signal lines and turning on the switching elements belonging to a group of the pixels corresponding to the each of the scanning signal lines, wherein

(1) the scanning signal driving circuit has a decoder varying an output voltage of the scanning signal from the scanning signal driving circuit, the output voltage of the scanning signal decreases as the scanning signal line to which the scanning signal is applied is located closer to the video signal driving circuit.

<<Display Device 9>>

A ninth example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface, each of which has a switching element and receives a video signal from one of the plurality of video signal lines in response to an application of a scanning signal to the switching element by one of the plurality of scanning signal lines; a scanning signal driving circuit outputting the scanning signal to each one end of the plurality of scanning signal lines, and a plurality of video signal driving circuits juxtaposed along at least one of the plurality of scanning signal lines, each of the plurality of video signal driving circuits outputs the video signal to each of a group of the plurality of video signal lines corresponding to the each of the plurality of video signal driving circuits, wherein

(1) the video signal has a voltage in accordance with a tone to be displayed, the voltage is determined by and varies in accordance with a gradation forming voltage, and

(2) the gradation forming voltage at when one of the plurality of video signal driving circuits outputs the video signal is dropped in comparison with the gradation forming voltage at when another of the plurality of video signal driving circuits located further from the scanning signal line than the one of the plurality of video signal driving circuits outputs the video signal.

<<Display Device 10>>

A tenth example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface, each of which has a switching element and receives a video signal from one of the plurality of video signal lines in response to an application of a scanning signal to the switching element by one of the plurality of scanning signal lines; a scanning signal driving circuit outputting the scanning signal to each one end of the plurality of scanning signal lines; and at least one video signal driving circuit outputting the video signal to each one end of the plurality of video signal lines, wherein

(1) an output of the video signal to respective one of the video signal lines is delayed sequentially as far from the scanning signal driving circuit as the respective one of the video signal lines is located.

<<Display Device 11>>

A eleventh example of display devices according to the present invention comprises, a plurality of scanning signal lines juxtaposed on a substrate surface; a plurality of video signal lines juxtaposed transverse to the plurality of gate signal lines; a plurality of pixels arranged two-dimensionally on the substrate surface to form a display area, each of the pixels has a switching element and receives a video signal from one of the plurality of video signal lines in response to an application of a scanning signal to the switching element by one of the plurality of scanning signal lines; an operation means to which display data are inputted; and a video signal driving circuit outputting the video signal to each of the plurality of video signal lines on the basis of an output of the operation means, wherein

the operation means

(1) receives information related to brightness inclination in the display area,

(2) detects a portion of the display area where the brightness inclination might appear and a minimum brightness level or a brightness level closer to the minimum brightness level in the portion thereof with reference to the information, and

(3) outputs a correction data decreasing the brightness of the display data in another portion thereof without a possibility of the brightness inclination and increasing the brightness of the display data in the portion thereof having a possibility of the brightness inclination to compensate its brightness decrease with reference to the minimum brightness level or the brightness level closer to the minimum brightness level to the video signal driving circuit.

<<Display Device 12>>

A twelfth example of display devices according to the present invention is applied to the aforementioned display device 11, wherein

(1) the operation means divides brightness range from a zero tone to another tone corresponding to the minimum brightness level or the brightness level closer to the minimum brightness level into a larger number of tones than a number of tones counted up from the zero tone to the another tone, and generates the correction data corresponding to the larger number of tones.

The present invention is not limited to the above-mentioned constitutions and various modifications are conceivable without departing from the technical concept of the present invention.

### BRIEF DESCRIPTION OF THE DRAWINGS

FIG. 1 is a plan view showing one example of the whole constitution of a liquid crystal display device as an example of a display device of the present invention;

FIG. 2 is a block diagram showing a source driver SD which is incorporated into a display device according to an embodiment 1 of the present invention;

FIG. 3 is a circuit diagram showing a portion corresponding to an amplifier of the above-mentioned source driver SD shown in FIG. 2;

FIG. 4 is an explanatory view of signals S0 to S3, driving capacities (driving performance) due to amplifying circuits A1, A2, A3, A4 and a waveform of a video signal applied to the pixel when scanning line position information are 30 and 700 respectively in a source driver SD which is incorporated in a display device (XGA-class) according to the embodiment 1 of the present invention;

FIG. 5 is a block diagram showing a portion of a source driver SD which is incorporated in a display device according to an embodiment 2 of the present invention;

FIG. 6 is an explanatory view showing a state of change of gradation forming voltages Vtop and tone voltages V0 to V7 obtained by the gradation forming voltages Vtop in response to scanning line position information due to selection of gate signal lines GL from a near end side to a far end side of the source driver SD shown in FIG. 5;

FIG. 7 is a block diagram showing a portion of a gate driver GD which is incorporated in a display device according to an embodiment 3 of the present invention;

FIG. 8 is a view showing a state of change of a scanning signals (ON-voltage) in response to scanning line position information due to selection of gate signal lines GL from a near end side to a far end side of the source driver SD and waveforms of scanning signals when the scanning line position information are 30 and 700 respectively in a display device according to the embodiment 3 of the present invention;

FIG. 9 is a block diagram showing a portion of a source driver SD which is incorporated in a display device according to an embodiment 4 of the present invention;

FIG. 10 is a view showing a state of change of gradation forming voltages Vtop in response to scanning line position information due to selection of gate signal lines GL from a near end side to a far end side of the source driver SD in a display device according to the embodiment 4 of the present invention;

FIG. 11 is a block diagram showing a source driver SD which is incorporated in a display device according to an embodiment 5 of the present invention;

FIG. 12 is a view showing a change of delay amounts of video signals from the source driver SD in response to scanning line position information due to selection of gate signal lines GL from a near end side to a far end side of the source driver SD in a display device according to the embodiment 5 of the present invention;

FIG. 13 is a block diagram showing a source driver SD which is incorporated in a display device according to an embodiment 6 of the present invention;

FIG. 14 is a view showing the relationship among a timing chart of frame starting information, latch pulses peculiar to the display device according to the embodiment 6 of the present invention and scanning line position information obtained by them;

FIG. 15 is a view showing the signal transmission between a display control circuit TCON and a source driver SD in a display device according to an embodiment 7 of the present invention;

FIG. 16 is a view showing the relationship between display data and scanning line position information transmitted to a display data bus shown in FIG. 15 and the scanning line position information latched in the source driver SD;

FIG. 17 is a circuit diagram showing a portion of the display device according to an embodiment 8 of the present invention, wherein the transmission of latch pulses out of signals between a display control circuit TCON and a source driver SD in a circuit diagram is shown;

FIG. 18 is a view showing the relationship between latch pulses transmitted from a display control circuit TCON to the source driver SD shown in FIG. 17 and scanning line position information superposed on the latch pulses;

FIG. 19 is an explanatory view showing a portion of a display device according to an embodiment 9 of the present invention, wherein the constitution of one gate driver GD out of a scanning signal driving circuit formed of a plurality of gate drivers GD is shown conceptually;

FIG. 20 is a circuit diagram showing an example of a decoder DD3 shown in FIG. 19, wherein only a portion of the decoder DD3 which outputs scanning signals to two arbitrary neighboring gate signal lines GL (n, n+1) is shown conceptually;

FIG. 21 is a timing chart showing the relationship between voltage selection signals n, n+1 which are inputted to respective voltage selection signals shown in FIG. 19 and the ON-voltages n+1, n+2 which are respectively outputted from voltage selection means;

FIG. 22 is a view showing a portion of a display device according to an embodiment 10 of the present invention and shows a neighboring pair ((n)th, (n+1)th) of a plurality of source drivers SD;

FIG. 23 is a timing chart showing the relationship among scanning signals which are inputted to an arbitrary gate signal line GL from a scanning signal driving circuit, a video signal which is outputted from the above-mentioned (n)th source driver SD, a video signal which is outputted from the above-mentioned (n+1)th source driver SD, and pixel voltages supplied to pixels corresponding to these signals;

FIG. 24 is a view showing a portion of a display device according to an embodiment 11 of the present invention and shows a neighboring pair ((n)th, (n+1)th) of a plurality of source drivers SD;

FIG. 25 is a view showing the constitution of a source driver SD incorporated in a display device according to an embodiment 12 of the present invention;

FIG. 26A and FIG. 26B are timing charts showing the relationship among latch pulses inputted to the source driver SD shown in FIG. 25, video signal outputted from the source driver SD and latch pulses inputted to a neighboring source driver SD in the direction away from the source driver SD and a scanning signal driving circuit, wherein FIG. 26A shows the timing chart when the source driver SD is arranged in the vicinity of the scanning signal driving circuit GD and FIG. 26B shows the timing chart when the source driver SD is arranged away from the scanning signal driving circuit GD respectively;

FIG. 27 is a constitutional view showing a portion of a display device according to an embodiment 13 of the present invention and shows an example of flow in which display data obtained by a computer or the like is inputted to a source driver;

FIG. 28A, FIG. 28B and FIG. 28C are explanatory views showing operation methods of operation means shown in FIG. 27, wherein FIG. 28A explains a drawback due to brightness inclination generated in a screen of a display device, FIG. 28B explains steps for correcting the brightness inclination using the operation means, and FIG. 28C shows a display brightness level on a screen of the above-mentioned display device obtained by correction processing executed by the operation means;

FIG. 29 is a constitutional view showing a portion of a display device according to an embodiment 14 of the present invention and shows an example of flow in which display data obtained from a computer or the like is inputted to a source driver SD; and

FIG. 30 is en explanatory view showing an operation method of multicolor operation means MCL shown in FIG. 29.

### DETAILED DESCRIPTION

Embodiments of a display device according to the present invention are explained hereinafter in conjunction with drawings.

In this embodiment, several types of liquid crystal display devices to which the present invention is applied are explained in detail as an example of an active matrix type display device. However, as has been described in the explanation of the BACKGROUND OF THE INVENTION, a signal transmission mode in an active matrix type liquid crystal display device (liquid crystal display panel) includes a large number of items which are common with items of an active matrix type electro luminescence display device and a field emission type display device. Accordingly, the signal transmission mode and the signal processing steps which feature the present invention and are explained hereinafter are applicable to active matrix type display devices other than the liquid crystal display device.

Embodiment 1.

<<Whole Constitution>>

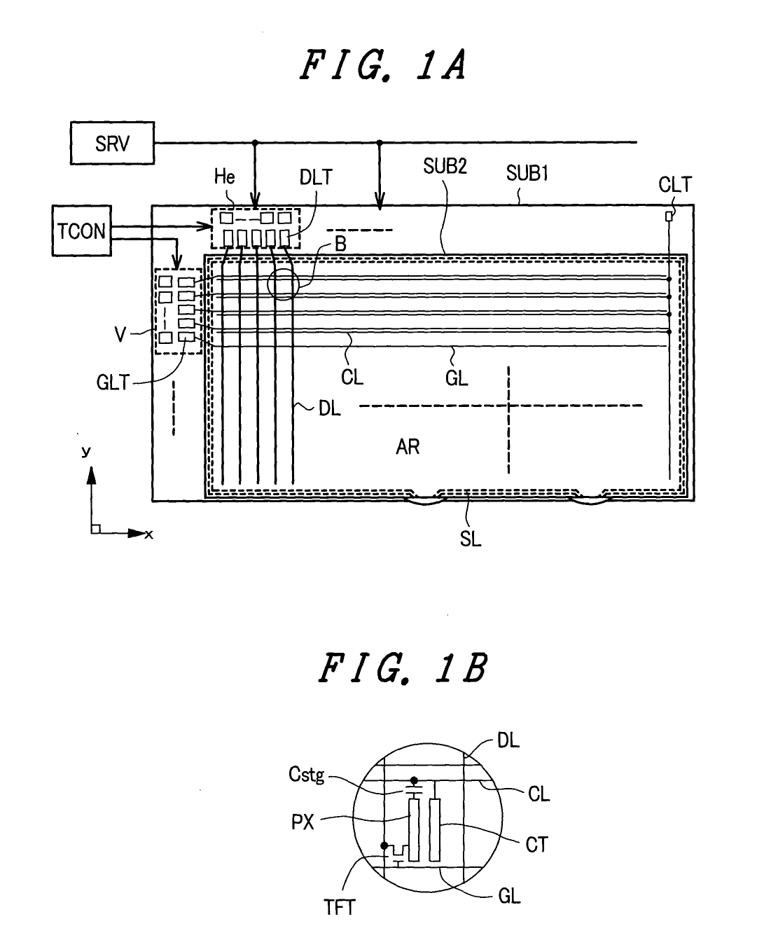

First of all, FIG. 1 is a plan view showing an embodiment of the whole constitution of a display device (liquid crystal display device) according to the present invention.

In FIG. 1, there are provided a pair of transparent substrates SUB1, SUB2 which are arranged to face each other with liquid crystal inserted therebetween, wherein the liquid crystal is sealed by a sealing material SL which is also served for fixing another transparent substrate SUB2 to one transparent substrate SUB1.

On a liquid-crystal-side surface of the above-mentioned one transparent substrate SUB1 which is surrounded by the sealing material SL, a plurality of scanning signal lines (hereinafter referred to as “gate signal lines”) GL which extend in the x direction and are juxtaposed in the y direction and a plurality of video signal lines (hereinafter referred to as “drain signal lines”) DL which extend in the y direction and are juxtaposed in the x direction are formed.

Respective pixel regions each of which is arranged corresponding to a region surrounded by a pair of gate signal lines GL out of the plurality of gate signal lines GL and a pair of drain signal lines DL out of a plurality of drain signal lines DL are arranged within a frame of the sealing material SL in a matrix array thus constituting an image display region (liquid crystal display part) AR which displays images.

Further, in respective pixel regions which are juxtaposed in the x direction, a common counter voltage signal line CL which runs within respective pixel regions is formed. The counter voltage signal line CL constitutes a signal line which supplies a voltage which becomes the reference with respect to the video signals to counter electrodes CT of respective pixel regions described later.

In each pixel region, a thin film transistor TFT which is operated in response to the scanning signal from the one-side gate signal line GL and a pixel electrode PX to which the video signal is supplied from the one-side drain signal line DL via the thin film transistor TFT are formed.

The pixel electrode PX generates an electric field between the pixel electrode PX and the counter electrode CT which is connected to the above-mentioned counter voltage signal line CL and the optical transmissivity of the liquid crystal is controlled in response to this electric field.

Respective ends of the gate signal lines GL extend over the sealing material SL and extension ends constitute terminals GLT to which output terminals of the scanning signal driving circuit V are connected. Further, to this scanning signal driving circuits V, scanning control signals are inputted from the display control circuit TCON.

The scanning signal driving circuit V is constituted of a plurality of semiconductor devices (hereinafter referred to as “gate drivers GD”), wherein a plurality of gate signal lines GL which are arranged close to each other are formed into a group and one semiconductor device is allocated to each group. Accordingly, the respective semiconductor devices are mounted such that they are juxtaposed in the parallel direction (y direction) of the respective gate signal lines GL.

In the same manner, respective ends of the drain signal lines DL extend over the sealing material SL and extension ends constitute terminals DLT to which output terminals of the video signal driving circuit He are connected. Further, to the video signal driving circuit He, video control signals are supplied from the display control circuit TCON and voltages corresponding to the tones are supplied from tone voltage forming means SRV.

The video signal driving circuit He is also constituted of a plurality of semiconductor devices (hereinafter referred to as “source drivers SD”), wherein a plurality of drain signal lines DL which are arranged close to each other are formed into a group and one semiconductor device is allocated to each group. Accordingly, the respective semiconductor devices are mounted such that they are juxtaposed in the parallel direction (x direction) of the respective drain signal lines DL.

Further, the above-mentioned counter voltage signal lines CL are, for example, connected in common at a right-side end portion in the drawing, a connection line extends over the sealing material SL, and the extension end constitutes a terminal CLT. From this terminal CLT, a voltage which becomes the reference with respect to the video signal is supplied.

Respective gate signal lines GL are sequentially selected one after another in response to scanning signals from the scanning signal driving circuit V.

On the other hand, to respective drain signal lines DL, video signals are supplied at the timing of selection of the gate signal lines GL due to the video signal driving circuit He.

Here, in the above-mentioned embodiment, although the scanning signal driving circuit V and the video signal driving circuit He are arranged such that they are constituted of semiconductor devices mounted on the transparent substrate SUB1, they may be constituted of so-called tape-carrier-method semiconductor devices which are connected between the transparent substrate SUB1 and the printed circuit board in a striding manner, for example. Further, when a semiconductor layer of the above-mentioned thin film transistor TFT is constituted of polycrystalline silicon (p—Si), the semiconductor elements made of the above-mentioned polycrystalline silicon may be formed on the transparent substrate SUB1 together with a wiring layer.

Further, in the above-mentioned embodiment, although the pixel electrodes PX and the counter electrodes CT are formed on the same substrate constituted of the transparent substrate SUB1, the counter electrodes CT may be formed on another transparent substrate SUB2 side. In this case, there has been known the constitution in which both of the pixel electrodes PX and the counter electrodes CT are formed as light transmitting conductive layers made of ITO (Indium Tin Oxide), ITZO (Indium Tin Zinc Oxide), IZO (Indium Zinc Oxide) or the like, the pixel electrode PX is formed to occupy a major portion of the pixel region, and the counter electrode CT is formed in common with respect to respective pixel regions.

<<Source Driver>>

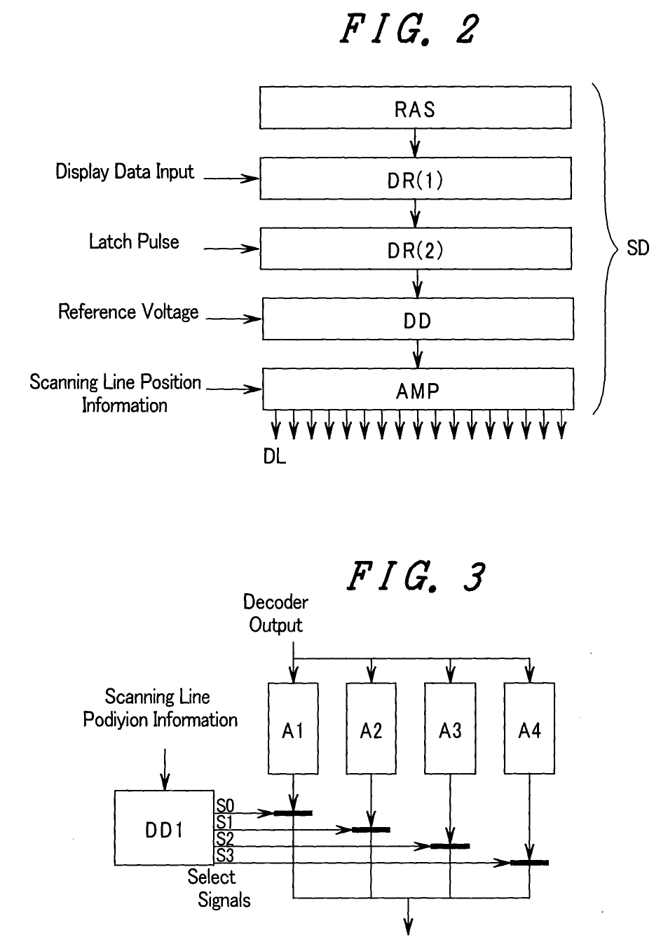

FIG. 2 is a block diagram showing one embodiment of the above-mentioned source driver SD. First of all, display data inputted from the outside of the liquid crystal display device are inputted to a data latch DR(1). The display data inputted to the data latch DR(1) are, for example, constituted of data to be supplied to a group of pixels arranged along one gate signal line GL of the liquid crystal display device, that is, data for one line.

A latch address selector RAS determines which address of the data latch DR(1) individual data which constitute the display data as a mass are latched.

The display data stored in the data latch DR(1) are shifted in parallel to a data latch DR(2) and hence, display data for next one line are stored in the data latch DR(1).

The display date stored in the data latch DR(2) are shifted to a decoder DD. With the use of the decoder DD, based on contents of individual data which form the mass, the display data are converted into video signals which are respectively formed of tone voltages. Here, shifting of the display data stored in the data latch DD(2) to the decoder DD is performed in response to latch pulses, and the tone voltages of the video signals are generated by dividing a reference voltage (gradation forming voltage) supplied to the decoder DD.

Further, the respective video signals converted into the tone voltages are amplified by an amplifier AMP and, thereafter, are supplied to the respective drain signal lines DL.

Then, in this embodiment, scanning line position information are configured to be inputted to the amplifier AMP. Here, the scanning line position information are information which specify the gate signal lines GL to which the scanning signals (ON-voltages) are supplied and are information which correspond to numbers that the respective gate signals GL are counted in order from the source driver SD side.

<<Amplifier>>

FIG. 3 is a circuit diagram showing one example of a portion of the source driver SD corresponding to the amplifier AMP. That is, FIG. 3 shows a circuit which is interposed in a path for supplying the signals from the pre-stage decoder DD to one drain signal line DL.

In FIG. 3, the amplifier includes four amplifying circuits A1, A2, A3, A4 respectively, wherein these amplifying circuits A1, A2, A3, A4 differ in driving capacity and the driving capacity is sequentially increased in order of respective amplifying circuits A1 to A4.

The signals from the above-mentioned decoder DD are respectively inputted to the respective amplifying circuits A1, A2, A3, A4 and the respective inputs are amplified and are outputted in response to respective driving capacities. For example, the intensity of the signal from the decoder DD is amplified twice by the amplifying circuit A1, four times by the amplifying circuit A2, eight times by the amplifying circuit A3, and sixteen times by the amplifying circuit A4, respectively.

On the other hand, the above-mentioned scanning line position information are inputted to the decoder DD1 and four signals S0, S1, S2, S3 are outputted in parallel in response to the scanning line position information.

In this case, in the decoder DD1, the whole gate signal lines GL are divided into 16 groups (=2⁴) in total by sequentially forming neighboring gate signal lines GL into groups from the source driver SD side. Here, when the above-mentioned scanning line position information belong to the group of gate signal lines which constitutes the first group, the respective signals S0, S1, S2, S3 respectively output signals of “1”, “0”, “0”, “0”. Further, when the above-mentioned scanning line position information belong to the group of gate signal lines which constitutes the next group, the respective signals S0, S1, S2, S3 respectively output signals of “0”, “1”, “0”, “0”. Still further, when the above-mentioned scanning line position information belong to the group of gate signal lines which constitute the next group, the respective signals S0, S1, S2, S3 respectively output signals of “1”, “1”, “0”, “0”. The intensity of the signals which are finally outputted from the amplifier AMP assumes a sum of the output signal from the amplifying circuit A1, the output signal from the amplifying circuit A2, the output signal from the amplifying circuit A3, and the output signal from the amplifying circuit A4.

Here, a signal of the above-mentioned signal S0 is a signal which determines whether the output from the above-mentioned amplifying circuit A1 is to be inputted to the drain signal line DL, a signal of the above-mentioned signal S1 is a signal which determines whether the output from the above-mentioned amplifying circuit A2 is to be inputted to the drain signal line DL, a signal of the above-mentioned signal S2 is a signal which determines whether the output from the above-mentioned amplifying circuit A3 is to be inputted to the drain signal line DL, and a signal of the above-mentioned signal S3 is a signal which determines whether the output from the above-mentioned amplifying circuit A4 is to be inputted to the drain signal line DL.

In this embodiment, for example, when the signal of the above-mentioned signal S0 is “1”, the output of the amplifying circuit A1 is outputted to the gate signal line GL, while when the signal of the above-mentioned signal S0 is “0”, the output of the amplifying circuit A1 is not outputted to the gate signal line GL.

That is, when the whole gate signal lines GL are divided into 16 groups (=2⁴) in total by sequentially forming neighboring gate signal lines GL into groups from the source driver SD side, in the group of gate signal lines which constitutes the first group, respective signals of the above-mentioned S0, S1, S2, S3 respectively assume signals of “1”, “0”, “0”, “0”. Accordingly, the signal which is amplified only through the amplifying circuit A1 (driving capacity “1”) is supplied to the drain signal line DL.

Further, based on the fact that in the group of gate signal lines which constitutes the next group, respective signals of the above-mentioned S0, S1, S2, S3 respectively assume signals of “0”, “1”, “0”, “0”, the signal which is amplified only through the amplifying circuit A2 (driving capacity “2”) is supplied to the drain signal line DL.

Still further, based on the fact that in the group of gate signal lines which constitutes the next group, respective signals of the above-mentioned S0, S1, S2, S3 respectively assume signals of “1”, “1”, “0”, “0”, the signals which are amplified through the amplifying circuit A1 (driving capacity “1”) and the amplifying circuit A2 (driving capacity “2”) are supplied to the drain signal line DL. That is, this implies that the signal which is amplified by the driving capacity “3” eventually is supplied to the drain signal line DL.

In this manner, also with respect to groups of gate signal lines which constitute respective succeeding groups, the signals whose driving capacities are sequentially increased are supplied to the drain signal lines DL till the group of gate signal lines which constitute the last group.

In other words, although the source driver SD must supply the video signals through the drain signal lines DL from the pixel close to the source driver SD to the pixel far from the source driver SD in response to scanning of respective gate signal lines GL, in this step, the voltage of the video signal is elevated for each stage after division into 16 (2⁴) stages. For example, in the display device of XGA class, 768 gate signal lines GL corresponding to the vertical resolution thereof are sequentially arranged from one end (source driver He side) of an image display region AR shown in FIG. 1. 768 gate signal lines GL are, for example, divided into 16 groups each consisting of 48 gate signal lines GL and the voltage of the video signal is changed for every group of gate signal lines GL. With respect to an image display operation during 1 frame period by the display device, the scanning signals are inputted to 768 respective gate signal lines GL from the source driver He side or the opposite side of the image display region AR and hence, respective 16 groups of the gate signal lines GL correspond to respective scanning stages included in 1 frame period. In dividing the plurality of gate signal lines GL which are juxtaposed in the image display region AR, it is not always necessary that the uniform number of gate signal lines GL belong to each group. For example, the number of the gate signal lines GL which are positioned at end portions of the image display region AR may be smaller than the number of the gate signal lines GL which belong to other group. The display device driven in this manner corresponds to the first example of the display device according to the present invention which is previously explained (display device 1).

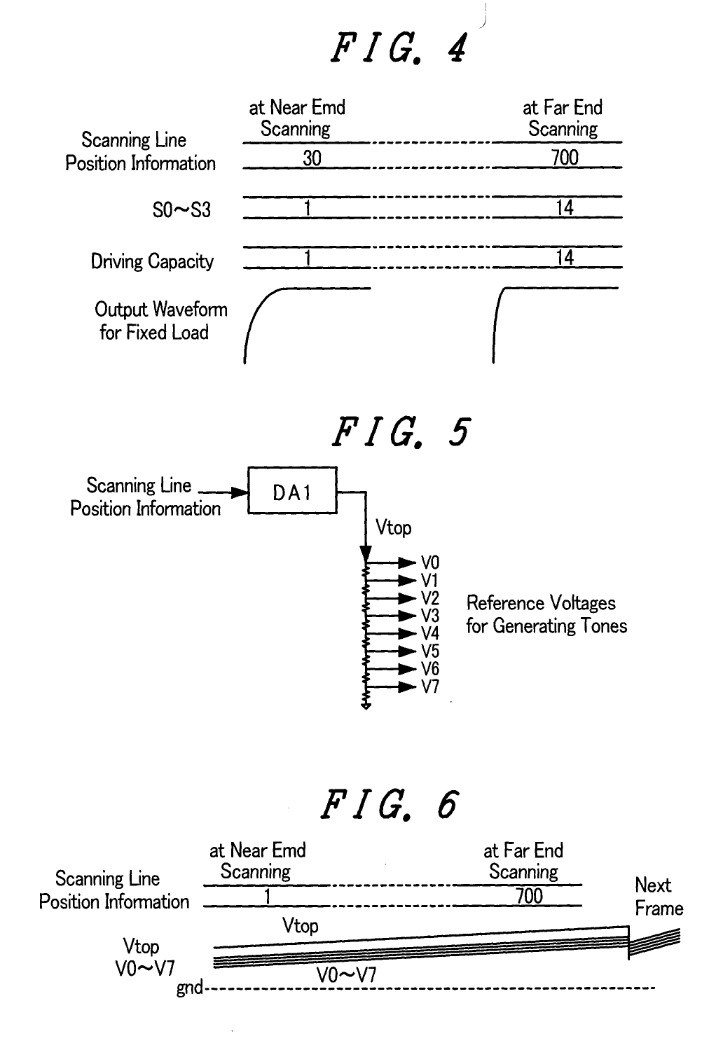

FIG. 4 is an explanatory view showing signals S0 to S3, driving capacities due to amplifying circuits A1, A2, A3, A4 and a waveform of the video signal applied to the pixels when scanning line position information (addresses of the gate signal lines GL when the scanning signals are inputted) are 30 and 700 respectively in a display device of XGA-class as an example.

In this case, the case that the scanning line position information is 30 corresponds the case in which the scanning signal is supplied to the 30th gate signal line GL counted from the source driver SD side, while the case that the scanning line position information is 700 corresponds the case in which the scanning signal is supplied to the 700th gate signal line GL counted from the source driver SD side.

Further, the fact that the signals of S0 to S3 assume 1 implies that respective signals of S0, S1, S2, S3 are respectively “1”, “0”, “0”, “0”, while the fact that the signals of S0 to S3 assume 14 implies that respective signals of S0, S1, S2, S3 are respectively “0”, “1”, “1”,“1”.

Further, the fact that the driving capacity due to the amplifying circuits A1, A2, A3, A4 assumes 1 implies that the decoder output only through the amplifying circuit A1 is supplied to the drain signal lines DL, while the fact that the driving capacity due to the amplifying circuits A1, A2, A3, A4 assumes 14 implies that the decoder output through the respective amplifying circuits A2, A3, A4 is supplied to the drain signal lines DL.

When the scanning line position information assume 30 and 700, for example, as the scanning line position information assume a larger value, the waveforms of video signals from the source drivers SD rise faster.

Then, with respect to the pixel corresponding to the above-mentioned each scanning line position information, a crest value is gradually decreased corresponding to a length of the drain signal lines DL due to the relationship on resistance or time constant and hence, the waveforms rise smoothly.

This implies that when the liquid crystal display part AR is observed as a whole, the waveforms of the video signals supplied to respective pixels become uniform and hence, it is possible to acquire a display which has no brightness inclination in the drain signal line DL direction.

Embodiment 2.

FIG. 5 is a circuit diagram showing a second example (display device 2) of the previously-mentioned display device according to the present invention. This embodiment is provided for changing the gradation forming reference voltage supplied to the decoder DD provided to the source driver SD shown in FIG. 2 in response to the scanning line position information.

That is, as shown in FIG. 5, the scanning line position information corresponds to the positions of the gate signal lines GL to which the scanning signals are supplied and constitute information corresponding to 1, 2, 3, . . . in order from the source driver SD side.

The scanning line position information are inputted to D/A conversion means DA1 and the gradation forming voltages Vtop are outputted in response to the values of the above-mentioned scanning line position information. That is, when the value of the scanning line position information is small, the small gradation forming voltage Vtop is outputted, while when the value of the scanning line position information is large, the large gradation forming voltage Vtop is outputted. In other words, this embodiment adopts the constitution in which the gradation forming voltage Vtop is set within a certain width and the voltage is increased sequentially within the width from the source driver SD side in response to the number of gate signal lines GL.

By obtaining the gradation forming voltage Vtop in this manner, as the tone voltage, it is possible to obtain the voltages which are classified into 8 stages such as V0, V1, V2, V3, V4, V5, V6, V7, for example, using divided voltage resistances.

Here, one of the respective tone voltages V0 to V7 is selected and outputted to the amplifier in response to the tone information included in the signal from the data latch DR(2) using the decoder DD of the source driver SD shown in FIG. 2.

FIG. 6 is an explanatory view showing a state of change of gradation forming voltage Vtop and a state of change of tone voltages V0 to V7 obtained by the gradation forming voltages Vtop in response to scanning line position information due to selection of gate signal lines GL from a near end side to a far end side of the source driver SD. Respective tone voltages V0 to V7 are changed in accordance with the change of the gradation forming voltage Vtop. The gradation forming voltage Vtop which is elevated along with the sequential inputting of the scanning signals to a plurality of gate signal lines GL juxtaposed on image display region AR and ranging from a gate signal line GL closest to the source driver SD (video signal driving circuit He) (indicative of the minimum scanning line position information) to a gate signal line GL farthest from the source driver SD (indicative of the maximum scanning line position information) falls to a value corresponding to the gate signal line GL closest to the source driver SD before the next frame period is started.

Accordingly, as the gate signal line GL arranged farther from the source driver SD, the video signal (tone voltage) outputted from the source driver SD is increased, whereby also in this embodiment, in the same manner as the embodiment 1, the waveforms of the video signals rise quickly.

Embodiment 3.

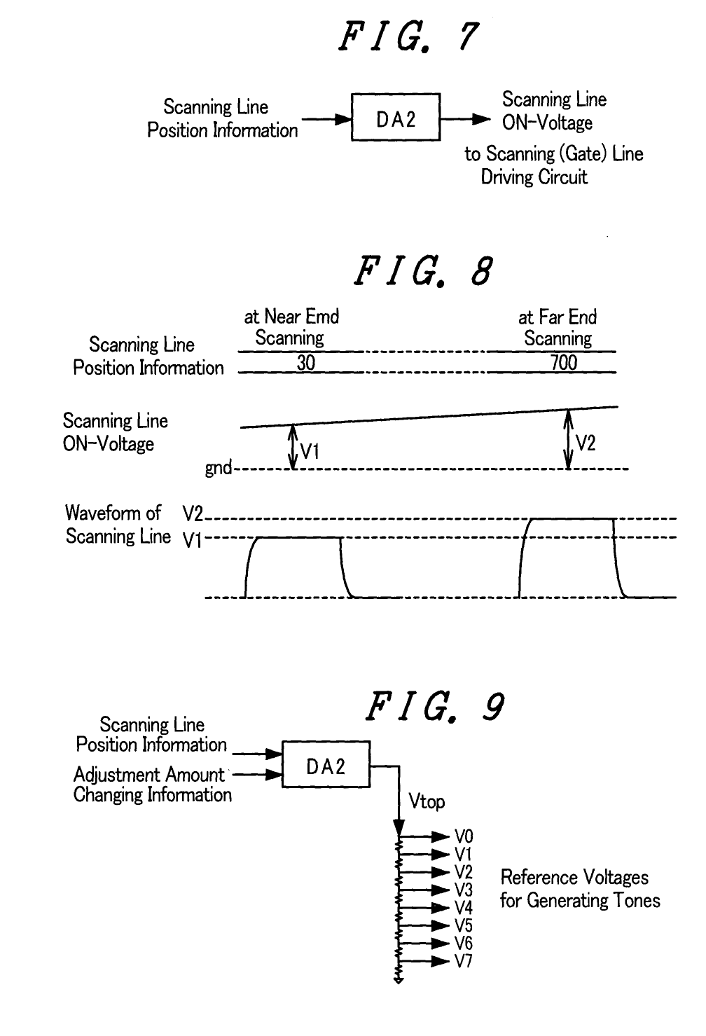

FIG. 7 is a circuit diagram showing a third example (display device 3) of the previously-mentioned display device according to the present invention, wherein the scanning signals (ON-voltages) supplied from the gate driver CD shown in FIG. 2 to respective gate signal lines GL can be changed in response to the scanning line position information.

That is, as shown in FIG. 7, the above-mentioned scanning line position information is inputted to D/A conversion means DA2 and the scanning signals (ON-voltages) having voltages corresponding to the scanning line position information are outputted from the D/A conversion means DA2. In other words, when the scanning line position information assume 1 (outputted when the scanning signal is supplied to the first gate signal line GL which is arranged close to the source driver SD), the scanning signal (ON-voltage) having the crest value at a rate of 1 is also outputted to the gate signal line GL, while when the scanning line position information assume 2 (outputted when the scanning signal is supplied to the second gate signal line GL which is arranged close to the source driver SD), the scanning signal (ON-voltage) having the crest value at a rate of 2 is also outputted to the gate signal line GL. Then, the similar operation is repeated in the succeeding steps.

FIG. 8 is a view showing a state of change of scanning signals (ON-voltages) in response to scanning line position information due to selection of gate signal lines GL from a near end side to a far end side of the source driver SD and waveforms of scanning signals by taking a case in which the scanning line position information are 30 and a case in which the scanning line position information are 700 as examples respectively.

The thin film transistor TFT of the pixel decreases a resistance value thereof even in the ON state when the voltage of the scanning signal is elevated. Accordingly, in writing the scanning signal (ON-voltage) to the pixel at the far end of the gate signal line GL, it is possible to decrease the time constant for writing. On the other hand, when the video signal (voltage) is written through the drain signal line DL, the farther the end of the drain signal line DL is, the more writing is delayed. Accordingly, both can be offset each other. As a result, it is possible to make the voltage applied to the pixel assume the similar voltage at the near end and the far end.

Embodiment 4.

FIG. 9 shows the improved circuit constitution of the source driver SD incorporated into the second example of the display device (display device 2) according to the present invention explained in conjunction with the embodiment 2 following FIG. 5.

The points which make the circuit constitution shown in FIG. 9 different from the circuit constitution shown in FIG. 5 lies in that the circuit constitution shown in FIG. 9 is configured such that as an input of the D/A conversion means DA2, adjustment amount changing information is inputted besides the scanning line position information.

The adjustment amount changing information are information which change values thereof depending on the size of the liquid crystal display panel or the difference in the constitution of the pixel. This is because a load of the drain signal line DL is changed corresponding to the size of the liquid crystal display panel or the difference in the constitution of the pixel.

The adjustment amount changing information are generated by arbitrarily inputting data of values such as 1, 2, 3, . . . , for example.

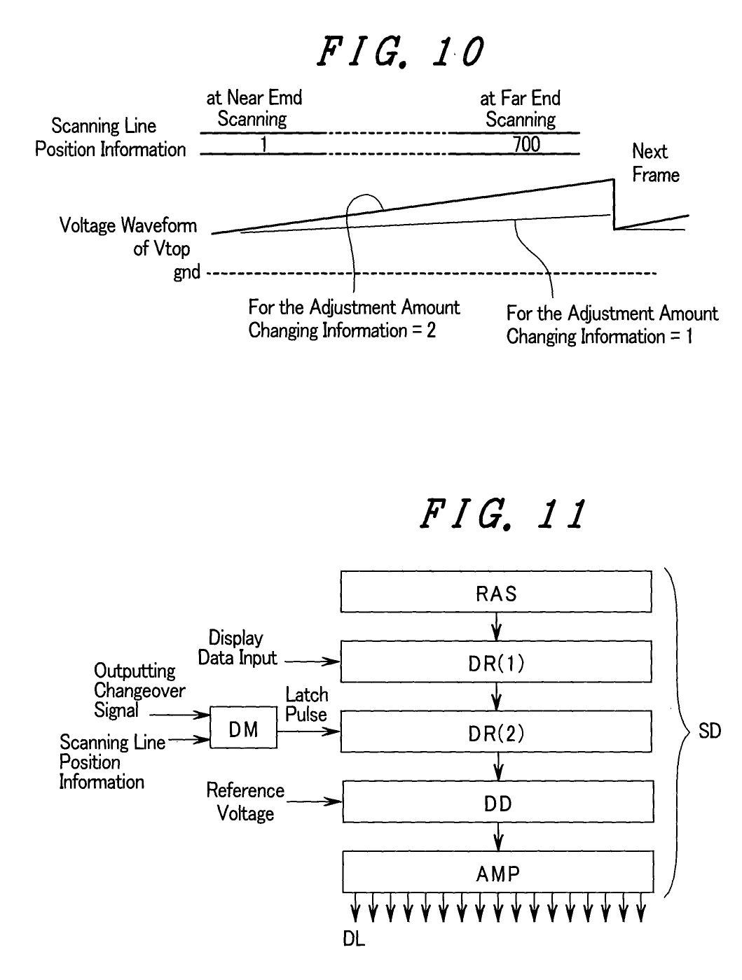

FIG. 10 is a view showing a state of change of gradation forming voltages Vtop in response to scanning line position information due to selection of gate signal lines GL from a near end side to a far end side of the source driver SD. That is, the drawing shows that inclination of the gradation forming voltage Vtop is changed in response to the value (for example, 1 and 2) of the adjustment amount changing information.

Due to such a constitution, it is possible to obtain the optimum voltage adjusting amount with respect to the liquid crystal display panels having various sizes or resolutions.

Embodiment 5.

FIG. 11 shows a source driver SD which is provided to a fourth example (display device) of the previously-mentioned display device according to the present invention and peripheral circuits thereof following FIG. 2.

As shown in FIG. 11, this embodiment is characterized in that a latch pulse inputted to a data latch DR(2) of the source driver SD shown in FIG. 2 is used as an outputting changeover signal, and the outputting changeover signal is delayed in response to the scanning line position information, and the delayed signal is used as a newly formed latch pulse.

To delay means DM shown in FIG. 11, the above-mentioned outputting changeover signal and the scanning line position information are inputted. Further, the latch pulse which is an output of the delay means DM is inputted to the data latch DR(2).

Here, the scanning line position information are constituted of values which indicate the positions of the gate signal lines GL which supply the scanning signal counted from the source driver SD side and are information corresponding to 1, 2, 3 . . . for example.

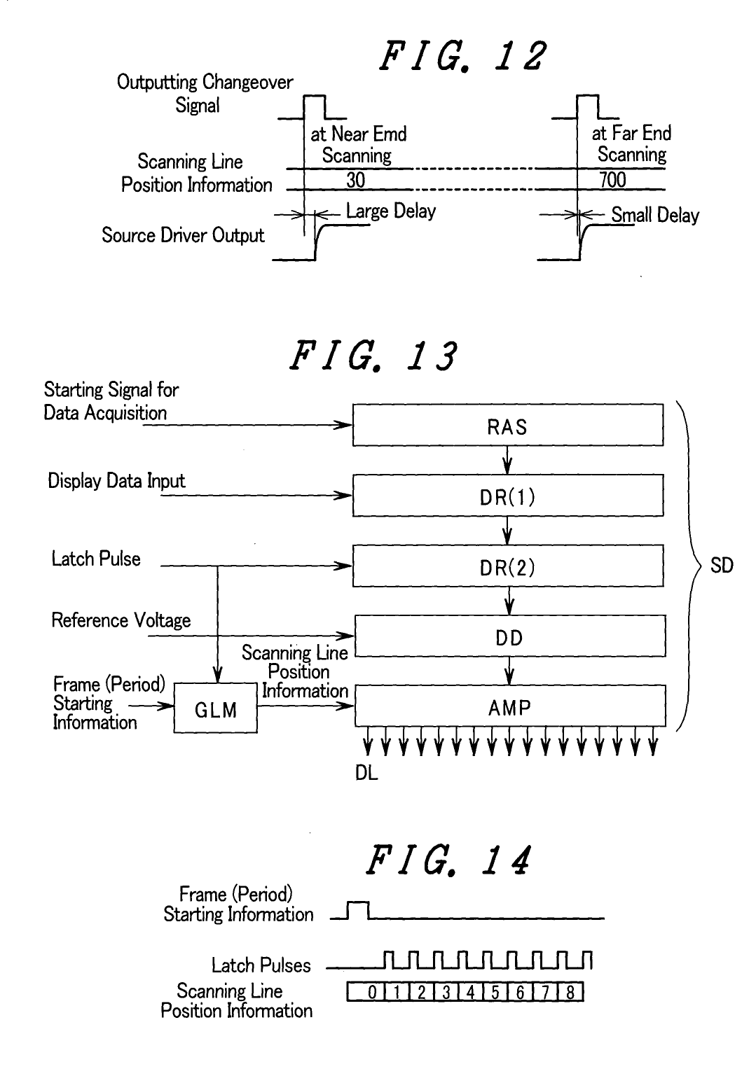

FIG. 12 is a view showing a state of change of delay amounts of video signals from the source driver SD in response to scanning line position information due to selection of gate signal lines GL from a near end side to a far end side of the source driver SD.

That is, for example, when the scanning line position information is 30, the delay amount of the video signal from the source driver SD is relatively large, while when the scanning line position information is 700, the delay amount of the video signal from the source driver SD is relatively small. The delay amount of the video signal is sequentially inversely decreased corresponding to the increase of the value of the scanning line position information.

Due to such a constitution, the voltage (video signal) writing time to the pixel positioned at the near end of the source driver SD can be made short, while the voltage (video signal) writing time to the pixel positioned at the far end of the source driver SD can be made long. As a result, the writing of voltage (video signal) applied to respective pixels can be made substantially equal at the near end and at the far end.

Embodiment 6

FIG. 13 is a circuit diagram of a source driver SD provided to a fifth example (display device 5) of the previously-mentioned display device according to the present invention and a periphery thereof following FIG. 2.

This embodiment is characterized in that the scanning line position information used in the above-mentioned respective embodiments are obtained using scanning line position measurement means GLM which is incorporated in the source driver SD. A starting signal for data acquisition is inputted to a latch address selector RAS, while display data are inputted to a data latch DR(1).

In FIG. 13, first of all, 1 pulse which is taken out for every 1 line information of display data and is inputted to a data latch DR(2) of the source driver SD, that is, a latch pulse is configured to be also inputted to the scanning line position measurement means GLM.

Frame starting information is inputted to the scanning line position measurement means GLM such that an up-counting of the latch pulses is started in response to the frame starting information. Accordingly, when the gate signal lines GL are sequentially scanned from the source driver SD side, the scanning line position information corresponding to 1, 2, 3, 4, . . . can be obtained in response to the sequential scanning.

In this embodiment, the scanning line position information are outputted to the amplifier, for example. However, the outputting address is not limited to the amplifier and the scanning line position information can be inputted to any required circuit in the respective embodiments explained heretofore or in respective embodiments described hereinafter.

FIG. 14 is a view showing the relationship among a timing chart of the above-mentioned frame starting information and latch pulses and scanning line position information obtained by them. Here, it is needless to say that when the next frame starting information is inputted, the scanning line position measurement means resets the counter value which has been counted until such inputting of the next frame starting information.

Accordingly, it is sufficient to provide only the input terminal of the frame starting information to the source driver SD and hence, the constitution can be simplified.

Embodiment 7

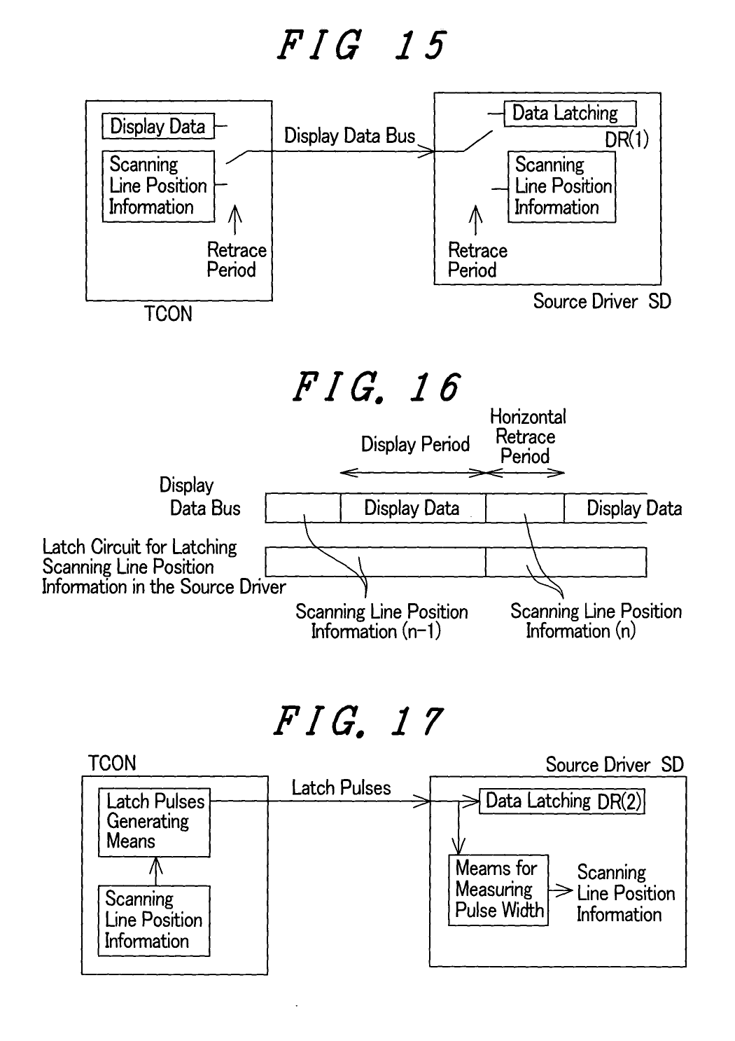

FIG. 15 is a circuit block diagram showing the signal transmission between a display control circuit TCON and a source driver SD in a display device in a sixth example(display device 6) of the previously-mentioned display device according to the present invention.

In FIG. 15, the display data are transmitted to the source driver SD from the display control circuit TCON, wherein the display data include retrace periods between data for one line.

Then, the display control circuit TCON transmits the scanning line position information during these retrace periods. In this case, a display data bus can be changed over from the transmission of display data to the transmission of scanning line position information at the time of changeover from the transmission time of the display data to the retrace periods.

On the other hand, in the source driver SD, the display data are inputted to the data latch DR(1) at the time of inputting display data, and the scanning line position information can be obtained during other retrace periods.

FIG. 16 is a view showing the relationship between display data and scanning line position information transmitted to the display data bus and the scanning line position information latched in the source driver SD.

Due to such a constitution, it is unnecessary to provide particular signal terminals to both of the display control circuit TCON and the source driver SD.

Embodiment 8.

FIG. 17 is a circuit block diagram showing the transmission of signals (latch pulses) between the display control circuit TCON and the source driver SD in a seventh example (display device 7) of the previously-mentioned display device according to the present invention.

In FIG. 17, scanning line position information are superposed on respective latch pulses transmitted to the source driver SD from the display control circuit TCON.

That is, the scanning line position information are inputted to the latch pulse generating means in the display control circuit TCON, wherein the scanning line position information which respond to the size of widths of the latch pulses outputted from the latch pulse generating means are superposed on the latch pulses.

Along with sequential inputting of the scanning line position information in order of 1, 2, 3, 4 . . . , the latch pulses are transmitted to the source driver SD while increasing the widths thereof one time, two times, three times, four times, . . . respectively. In this case, the respective latch pulses drive the data latch DR(2) with their rises. In other words, the display control circuit TCON is provided with means to convert the widths of the latch pulses in response to the scanning line position information.

Further, the above-mentioned respective latch pulses which are inputted to the source driver SD are also inputted to means for measuring pulse width at a pre-stage before inputting the latch pulses to the data latch DR(2) and the scanning line position information corresponding to 1, 2, 3, 4, . . . are fetched by the means for measuring pulse width. In other words, the source driver SD is provided with means for reading out the above-mentioned scanning line position information from the widths of the above-mentioned latch pulses.

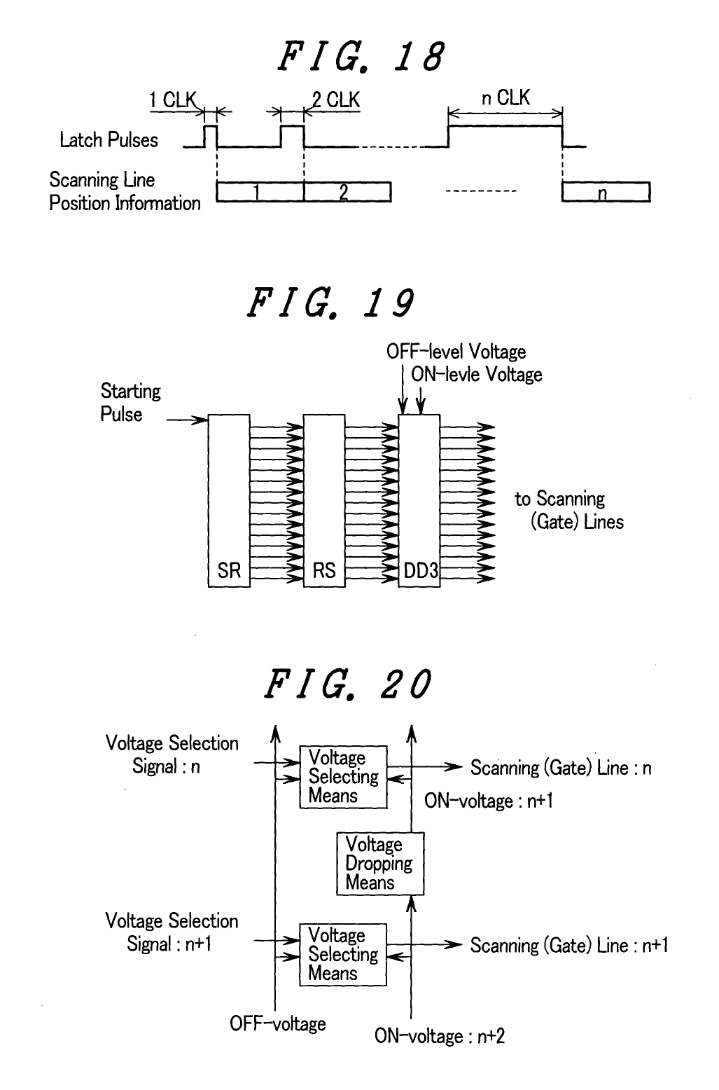

FIG. 18 is a view showing the relationship between latch pulses transmitted from the display control circuit TCON to the source driver SD and scanning line position information superposed on the latch pulses.

Due to such a constitution, it is unnecessary to provide particular signal terminals to both of the display control circuit TCON and the source driver SD.

Embodiment 9.

FIG. 19 shows one characteristic portion of the gate driver GD included in the scanning signal driving circuit V which is constituted of a plurality of gate drivers GD provided to an eighth example (display device 8) of the previously-mentioned display device of the present invention.

As shown in FIG. 19, a starting pulse is inputted to a shift register SR and the shift register SR sequentially outputs signals from respective output terminals thereof. These signals are inputted to a level shifter RS and are converted into given voltage values and are outputted from the level shifter RS as voltage selection signals.

Further, these voltage selection signals are inputted to a decoder DD3 and scanning signals (ON-signals) which are set to given voltages are outputted to the respective gate signal lines GL from the decoder DD3. In this case, the scanning signals (ON-signals) which are supplied to the respective gate signal lines GL have voltages thereof sequentially increased as the gate signal lines GL are located farther from the source driver SD side.

FIG. 20 is a circuit diagram showing an example of the constitution of the above-mentioned decoder DD3, wherein a portion of the decoder DD3 which outputs scanning signals to two arbitrary neighboring gate signal lines GL (n, n+1) is shown.

In the decoder DD3, the nth gate signal line GL is connected to voltage signal selecting means VSn, while the (n+1)th gate signal line GL is connected to voltage signal selecting means VSn+1.

The corresponding voltage selection signal n from the level shifter is configured to be inputted to the voltage signal selecting means VSn together with an OFF-voltage. Further, the corresponding voltage selection signal n+1 from the level shifter is configured to be inputted to the voltage signal selecting means VSn+1 together with the above-mentioned OFF-voltage.

Further, ON-voltages are configured to be inputted to the respective voltage selecting means VSn and VSn+1. With respect to these ON-voltages, signals which are respectively subjected to voltage drop by voltage dropping means for respective gate signal lines GL from the direction opposite to the source driver SD are inputted to the respective voltage selecting means VSn and VSn+1. For example, the ON-voltage n+1 is inputted to the voltage selecting means VSn+1 and the ON-voltage n is inputted to the voltage selecting means VSn.

Then, in the voltage selecting means VSn, the ON-voltage n+1 is selected in response to inputting (ON-signal) of the voltage selection signal n, while the OFF voltage is selected in other cases (OFF-signal). In the same manner, in the voltage selecting means VSn+1, the ON-voltage n+2 is selected in response to inputting (ON-signal) of the voltage selection signal n+1 (ON-signal) while the OFF voltage is selected in other cases (OFF-signal).

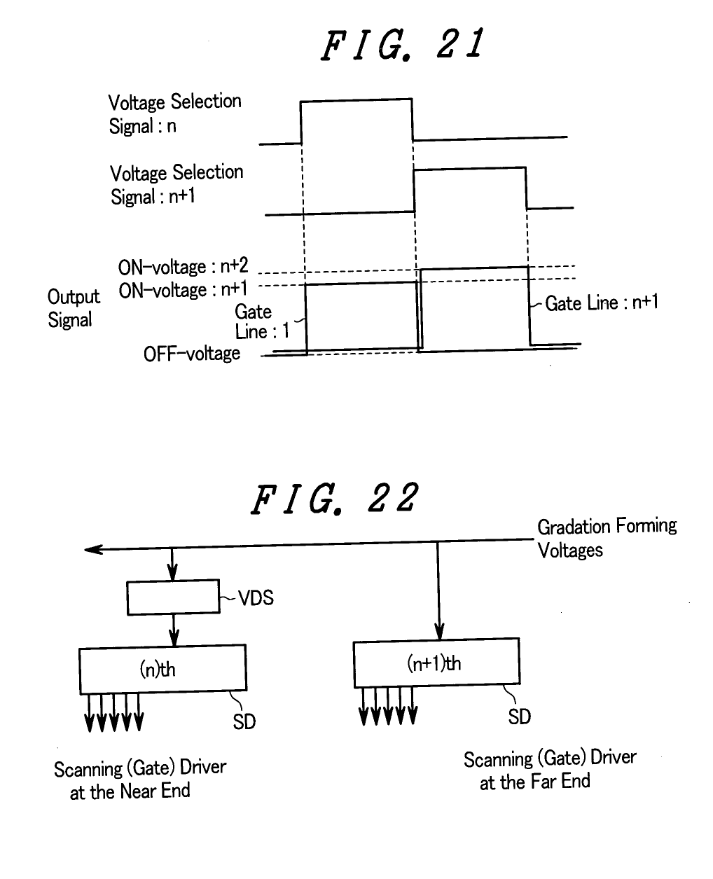

FIG. 21 is a timing chart showing the relationship between voltage selection signals n, n+1 which are respectively inputted to the above-mentioned voltage selecting means VSn, VSn+1 and the ON-voltages n+1, n+2 which are respectively outputted from voltage selecting means VSn, VSn+1. The scanning signal (ON-signal) supplied to the gate signal line GL(n+1) assumes a voltage value larger than scanning signal (ON-signal) supplied to the gate signal line GL(n).

Embodiment 10.

FIG. 22 shows two neighboring (n)th and (n+1)th source drivers SD out of a plurality of source drivers SD which are juxtaposed in a periphery of an image display region of a ninth example (display device 9) of the previously-mentioned display device of the present invention.

Here, the (n)th source driver SD is positioned at the scanning signal driving circuit V side and the (n+1)th source driver SD is positioned at a side far from the scanning signal driving circuit V side.

Gradation forming voltages inputted to respective source drivers SD are configured to be subjected to a voltage drop by voltage dropping means VDS when they are inputted to the source driver SD indicated by n, wherein the gradation forming voltages assume voltage values which are smaller than the gradation forming voltages inputted to the source driver SD indicated by n+1.

That is, to source drivers SD ranging from the source driver SD far from the scanning signal driving circuit V to the source driver SD near to the scanning signal driving circuit V, the gradation forming voltages which are sequentially subjected to the voltage drop are inputted and video signals corresponding to the gradation forming voltages are inputted to the respective drain signal lines DL.

FIG. 23 is a timing chart showing the relationship among scanning signals which are inputted to an arbitrary gate signal line GL from a scanning signal driving circuit V, a video signal which is outputted from the above-mentioned (n)th source driver SD, a video signal which is outputted from the above-mentioned (n+1)th source driver SD, and pixel voltages supplied to pixels corresponding to these source drivers SD.

As the scanning signal is located farther from the scanning signal driving circuit V, a strain is generated in a waveform thereof and, at the same time, as the video signal is located farther from the scanning signal driving circuit V, a voltage value thereof is elevated. Due to such operations, the pixel voltage supplied to the pixel can obtain the substantially uniform waveform irrespective of the difference in distance from the scanning signal driving circuit V.

Accordingly, it is possible to prevent the occurrence of unevenness of brightness which occur due to the difference in distance from the scanning signal driving circuit V.

Embodiment 11

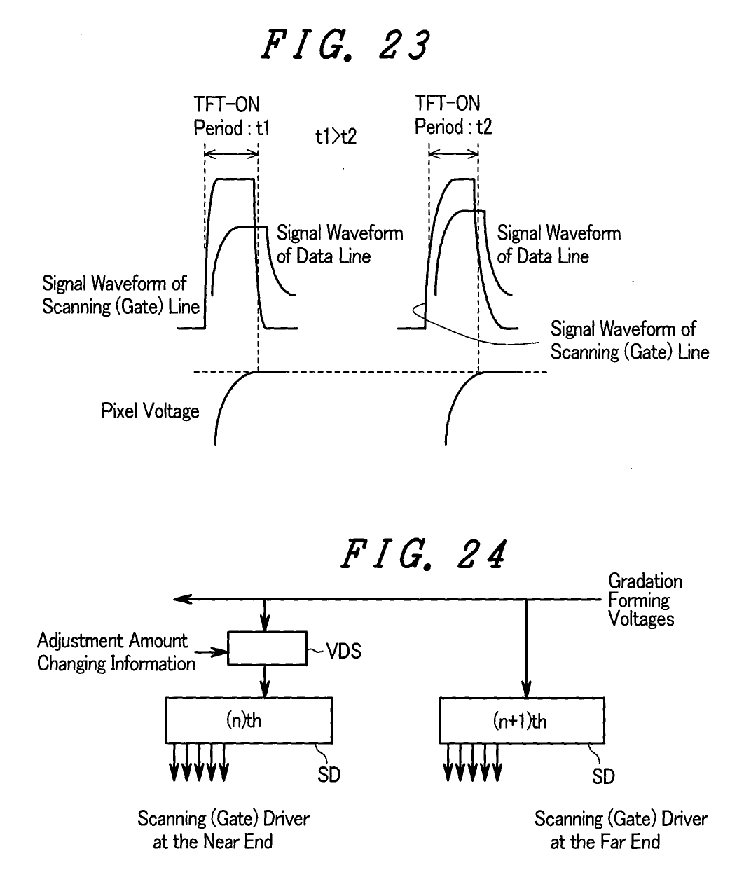

FIG. 24 shows the improved constitution of the display device 9 according to the present invention which is explained in conjunction with the embodiment 10.

That is, while the gradation forming voltages are inputted to the respective source drivers SD through the corresponding voltage dropping means (the adjustment amount changing information is inputted thereto as FIG. 24 shows) VDS, adjustment amount changing information are inputted to the respective voltage dropping means VDS.

The adjusting amount changing information are formed of information which are set corresponding to different types of liquid crystal display panels which differ in size and the respective voltage dropping means determine the voltage dropping amount in response to inputting of the adjusting amount changing information.

Embodiment 12.

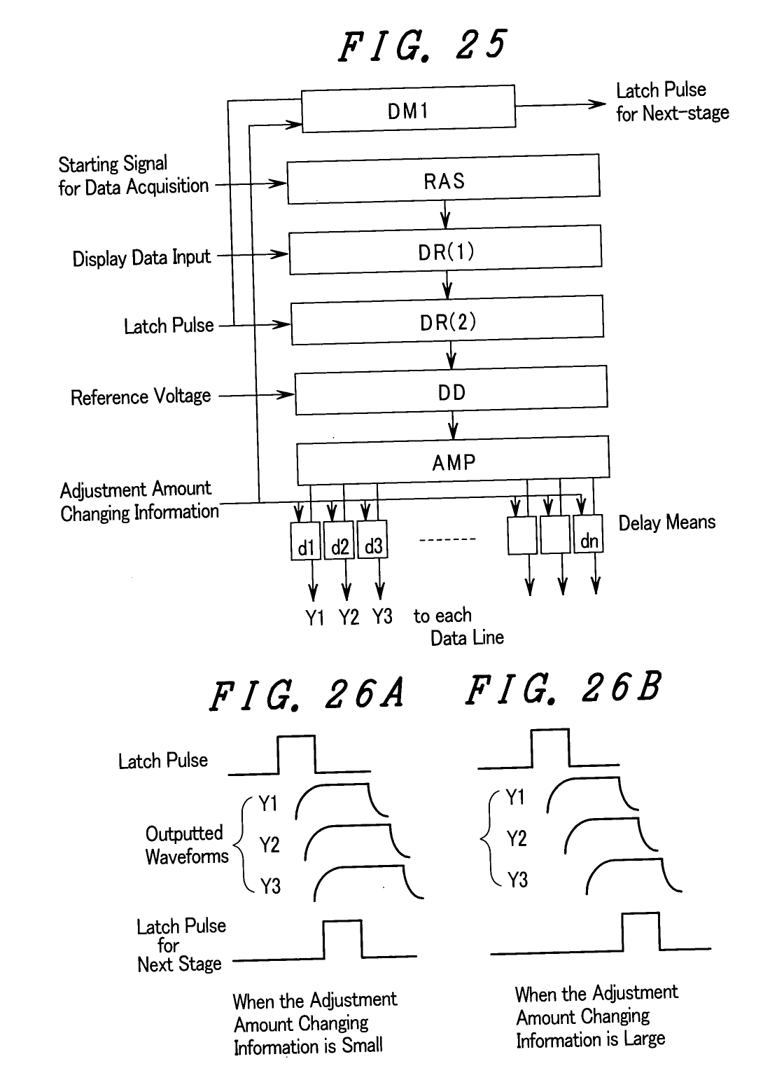

FIG. 25 shows the constitution of the source driver SD of a tenth example (display device 10) of the previously-mentioned display device according to the present invention.

This embodiment is characterized in that the respective video signals from the source driver SD are supplied to the respective drain signal lines DL which are gradually located farther from the scanning signal driving circuit V in a sequentially delayed manner in response to delay of the scanning signals in the gate signal lines GL which are located farther from the scanning signal driving circuit V.

That is, in the source driver SD including a latch address selector RAS, a data latch DR(1), a data latch DR(2), a decoder DD and an amplifier AMP, along with inputting of latch pulses which are inputted to the data latch DR(2) of the source driver SD, the respective video signals which are outputted from the amplifier AMP have delay amounts thereof sequentially increased as the video signals are located farther from the scanning signal driving circuit V due to respective delay means d1, d2, d3, . . . dn and, thereafter, are supplied to the respective drain signal lines DL.

In this case, the latch pulses are inputted to the delay means DM1 and the delayed latch pulses are inputted to the data latch DR(2) of the source driver SD which is arranged close to the delay means DM1 in the direction away from the scanning signal driving circuit V The delay amounts of the latch pulses by this delay means DM1 are set such that after one source driver SD supplies the video signals while sequentially delaying the respective drain signal lines DL, the first video signals of the neighboring source driver SD are supplied to the respective drain signal lines DL with substantially same delay amounts.

Due to such a constitution, the video signal driving circuit He which is constituted of a plurality of juxtaposed source drivers SD can sequentially supply the video signals to respective drain signal lines DL which are sequentially juxtaposed from the scanning signal driving circuit V side with the same delay amounts sequentially.

Further, this embodiment is configured such that the adjustment amount changing information are inputted to the above-mentioned respective delay means d1, d2, . . . dn and DM1. This provision is made to input, in the same manner as the embodiment 10, suitable values corresponding to the types of the liquid crystal display panels including sizes thereof to the delay means thus allowing the delay means to set the optimum delay amounts.

FIG. 26A and FIG. 26B are timing charts showing the relationship among latch pulses inputted to the source driver SD, video signals outputted from the source driver SD and latch pulses inputted to a neighboring source driver SD in the direction away from the source driver SD and a scanning signal driving circuit, wherein FIG. 26A shows the timing chart when the adjustment amount changing information is small and FIG. 26B shows the timing chart when the adjustment amount changing information is large.

Embodiment 13.

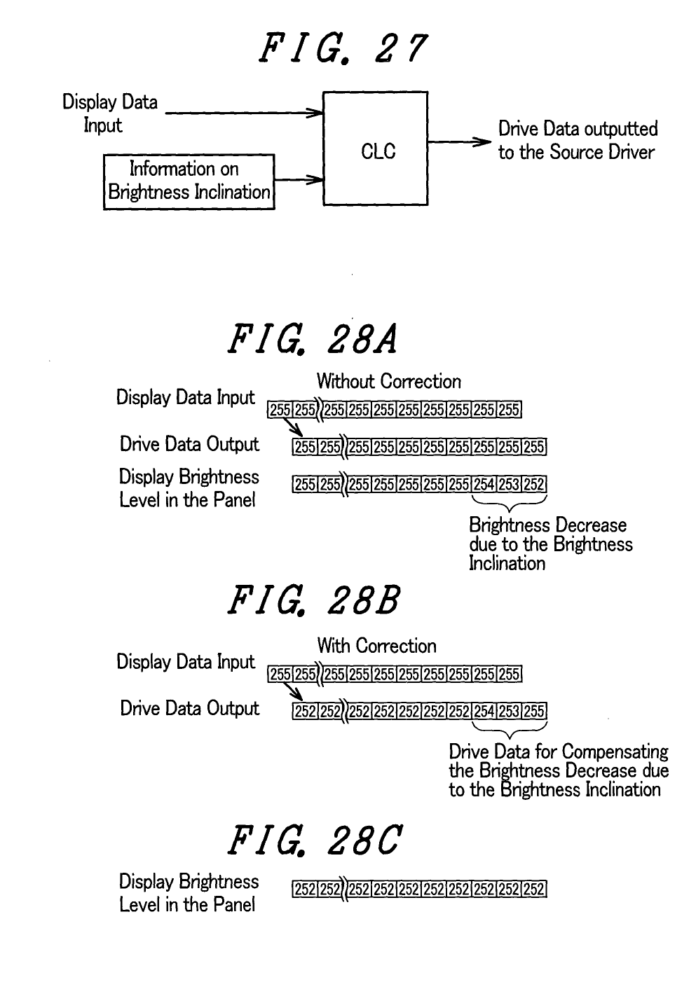

FIG. 27 is a circuit block diagram which features an eleventh embodiment (display device 11) of the previously mentioned display device according to the present invention, wherein arithmetic means CLC is provided as a pre-stage of a path for inputting the display data transmitted to the source driver SD from a computer or the like.

Information on in-plane brightness inclination are inputted as an input to the arithmetic means CLC in addition to the above-mentioned display data, while brightness data which are inputted to the source driver SD are outputted from the arithmetic means CLC as an output.

FIG. 28A corresponds to information on the above-mentioned in-plane brightness inclination, wherein the information are prepared in following steps. First of all, white data (brightness 255) which constitute display data to be supplied to respective pixels of the liquid crystal display device are prepared and the white data are directly inputted to the liquid crystal display device as the brightness data. Then, the display brightness levels of respective pixels displayed by the white data are measured.

FIG. 28A shows a group of respective pixels along the gate signal line GL, for example. The respective display brightness levels of the group of pixels can be measured as 255, 255, 255, 255, . . . 255, 254, 253, 252 from the scanning signal driving circuit side, wherein the brightness is sequentially lowered from the third pixel counted from the last.

These respective display brightness levels are used as the above-mentioned information on in-plane brightness inclination and are inputted to the above-mentioned arithmetic means. The arithmetic means, first of all, recognizes that, as shown in FIG. 28B, the lowest brightness level is 252 based on the respective display brightness levels and, thereafter, converts the brightness data of the pixels which do not exhibit lowering of brightness in view of the display brightness level to the brightness level 252. That is, the arithmetic means converts the brightness level of these pixels from 255 to 252.

Then, with respect to the respective pixels which are located far from the scanning signal driving circuit V side, the brightness data which are supplied to the respective pixels ranging from the third pixel from the last to the last pixel are increased with respect to the brightness data 252 which constitutes the reference by amounts corresponding to the sequential lowering of brightness.

Due to such a correction, the corrected brightness data exhibit 252, 252, 252, 252 . . . , 252, 253, 254, 255 from the scanning signal driving circuit V side. That is, the corrected brightness data sets the brightness of the portion where the brightness is lowered most as the reference brightness and the portions where the brightness is lowered have the brightness thereof enhanced with respect to the reference brightness by amounts corresponding to the lowering of brightness.

By inputting the corrected brightness data to the source driver SD as the brightness data, as shown in FIG. 28C, the brightness levels of the respective pixels displayed on the liquid crystal display panel become 252, 252, . . . 252, 252, 252, 252 and hence, the unevenness of brightness can be eliminated.

In this case, the whole brightness displayed on the liquid crystal display panel is lowered from 255 to 252. When it is necessary to have the brightness corresponding to the brightness 255, such brightness can be obtained by slightly increasing a light quantity of a backlight which is arranged on a back face of the liquid crystal display panel, for example.

In the above-mentioned explanation, to facilitate the understanding of this embodiment, the driving data which is inputted to the source driver SD are set as white display data. However, driving data for usual video use can be also directly applicable to this embodiment. That is, based on the information on the in-plane brightness inclination, the regions where the brightness inclination is generated are recognized. Then, the lowest brightness level (or the brightness level close to the lowest brightness level) in the region is recognized. Further, using the lowest brightness level (or the brightness level close to the lowest brightness level) as the reference level, the brightness of the display data of regions where the brightness inclination is not generated is lowered corresponding to the brightness of the regions and, at the same time, the brightness of the display data of respective portions of regions where the brightness inclination is generated are enhanced with respect to the reference level by amounts corresponding to the lowering amounts of the brightness.

Here, the reason that it is not always necessary to use the lowest brightness level in the regions where the brightness inclination is generated as the brightness level is that it is sufficient when the brightness is uniform by the recognition with naked eyes.

Embodiment 14.

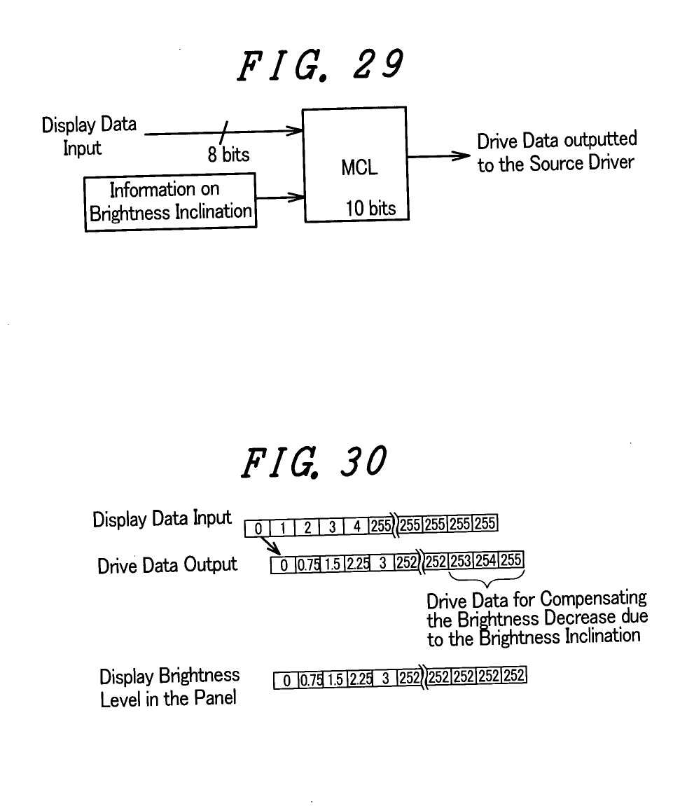

FIG. 29 is a circuit block diagram which features an twelfth embodiment (display device 12) of the previously mentioned display device according to the present invention, wherein multi-color arithmetic means MCL is provided at a pre-stage of a path for inputting the display data transmitted to the source driver SD from a computer or the like.

Information on in-plane brightness inclination are inputted as an input to the multi-color arithmetic means MCL in addition to the above-mentioned display data, while brightness data which are inputted to the source driver SD are outputted from the multi-color arithmetic means CLC as an output.

Although the multi-color arithmetic means MCL perform the substantially same operations as the arithmetic means CLC explained in conjunction with the embodiment 13, different from the arithmetic means CLC, the multi-color arithmetic means MCL is further provided with the constitution which distributes the respective tone of the obtained corrected data to 256 pieces, for example.

That is, although the corrected data obtained by the arithmetic means CLC explained in conjunction with the embodiment 13 is capable of performing the display of 256 tones, to obtain the uniform brightness, the arithmetic means CLC dare, for example acquire the number of display colors consisting of 252 tones.

Accordingly, in this embodiment, within the brightness range from zero tone to 252 tone which can be obtained by the embodiment 13, the tone is distributed to 256 tones so as to generate new tones ranging from zero tone to 255 tone whereby the number of display color which enables the image display of 256 tones in total can be achieved.

In FIG. 30, assume that the display data of 8 bits, for example, which are inputted to the multi-color arithmetic means are 0, 1, 2, 3, 4, 255, . . . 255, 255, 255, 255 and when the brightness of the pixels ranging from third pixel from the last to the last pixel sequentially lower the brightness in the same manner as the embodiment 13, the processing which is performed in conjunction with the embodiment 13 is performed with respect to three display data.

Then, with respect to the display data other than the above-mentioned three display data, the correction to distribute the tone to 256 pieces of tones is performed within the brightness range from zero tone to 252 tone.

Accordingly, the obtained correction data become 0, 0.75, 1.5, 2.25, 3, 252, . . . , 252, 253, 264, 255 and are outputted as the driving data. The corrected data have the number of display colors which can achieve the image display of the 256 tones in total.

The display brightness levels displayed on the liquid crystal display panel become 0, 0.75, 1.5, 2.25, 3, 252, . . . , 252, 252, 262, 252 and hence, it is possible not only to make the brightness uniform in the portions where the brightness inclination is generated but also to perform the display with the brightness range ranging from zero tone to 255 tone as a whole.

By combining the structures peculiar to the display devices (display devices 1 to 12) of the above-mentioned respective embodiments into one display device, it is possible to obtain synergistic advantageous effects.

Further, although the respective embodiments have been explained in conjunction with the liquid crystal display device as the example, it is needless to say that the structures peculiar to respective embodiments are applicable to image display devices (an organic EL display device, for example) other than the liquid crystal display device. Particularly, with respect to display devices which are driven using the active matrix method, the structures peculiar to respective embodiments are applicable in general.

As can be clearly understood from the foregoing description, according to the display device of the present invention, even when the display device becomes large-sized, it is possible to suppress the occurrence of unevenness of brightness.

What is claimed is:

1. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface; and
a video signal driving circuit connected to respective one end sides of the plurality of video signal lines, wherein
the plurality of pixels includes a first pixel selected by one of the scanning signal lines and a second pixel located closer to the video signal driving circuit than the first pixel and selected by another of the scanning signal lines, each of which receives a signal from one of the plurality of video signal lines sequentially in response to respective selection thereof and indicates brightness in accordance with the signal,
the signal is inputted to the one of the plurality of video signal lines through amplifying means from the video signal driving circuit, and
the amplifying means raises driving performance of the first pixel higher than that of the second pixel.

2. A display device according to claim 1, further comprises
means for adjusting the driving performance.

3. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface; and
a video signal driving circuit connected to the plurality of video signal lines respectively, wherein
one of the plurality of video signal lines supplies a video signal to one and another of the plurality of pixels sequentially, in response to when respective one of the scanning signal lines selects either the one or the another of the plurality of pixels, the another of the plurality of pixels is located closer to the video signal driving circuit than the one of the plurality of pixels, and each of the one and the another of the plurality of pixels indicates brightness in accordance with the video signal supplied from the one of the plurality of video signal lines,
the video signal has a voltage in accordance with a tone to be displayed, the voltage is determined by and varies in accordance with a gradation forming voltage, and
the gradation forming voltage is increased higher when the video signal is supplied to the one of the plurality of pixels than when the video signal is supplied to the another of the plurality of pixels.

4. A display device according to claim 3, further comprises
means for adjusting the gradation forming voltage.

5. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface, each of which has a switching element and receives a video signal from one of the plurality of video signal lines when the switching element is turned on by one of the plurality of scanning signal lines;
a video signal driving circuit connected to respective ends of the plurality of video signal lines, and
a scanning signal driving circuit inputting voltage signals turning on the switching elements video to the plurality of scanning signal lines respectively, wherein
the voltage signal inputted to one of the plurality of scanning signal lines is higher than that inputted to another of the plurality of scanning signal lines located closer to the video signal driving circuit.

6. A display device according to claim 5, further comprises
means for adjusting the voltage signal inputted to one of the plurality of scanning signal lines with reference to the voltage signal supplied to another of the plurality of scanning signal lines located further from the video signal driving circuit than the one of the plurality of scanning signal lines.

7. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface; and
a video signal driving circuit connected to respective one end sides of the plurality of video signal lines, wherein
the plurality of pixels includes a first pixel selected by one of the scanning signal lines and a second pixel located closer to the video signal driving circuit than the first pixel and selected by another of the scanning signal lines, each of which receives a signal from one of the plurality of video signal lines sequentially in response to respective selection thereof and indicates brightness in accordance with the signal,
the video signal driving circuit inputs the signal to the second pixel with larger delay than when the video signal driving circuit inputs the signal to the first pixel.

8. A display device according to claim 1, wherein
information on a start of frame and latch pulses corresponding to every one line of the display data are inputted to the video signal driving circuit,
the display device further comprises scanning line position measurement means counting the latch pulses according to an input of the information on the start of frame and outputting scanning line position information,
the scanning line position information determines whether one of the plurality of pixels is located closer to the video signal driving circuit than another of the plurality of pixels, or not.

9. A display device according to claim 1, further comprising a display control circuit, wherein
display data including retrace periods between every pair of line data thereof are transmitted from the display control circuit to the video signal driving circuit,
the display control circuit transmits scanning line position information related to the respective line data in each of the retrace periods,
the scanning line position information determines whether one of the plurality of pixels is located closer to the video signal driving circuit than another of the plurality of pixels, or not.

10. A display device according to claim 1, further comprising a display control circuit, wherein
the display control circuit transmits pulses to the video signal driving circuit,
the display control circuit comprises means for varying widths of the pulses in accordance with scanning line position information and means for reading the scanning line position information from the widths of the pulse,
the scanning line position information determines whether one of the plurality of pixels is located closer to the video signal driving circuit than another of the plurality of pixels, or not.

11. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface, each of which has a switching element and receives a video signal from one of the plurality of video signal lines in response to an application of a scanning signal to the switching element by one of the plurality of scanning signal lines;
a video signal driving circuit connected to respective ends of the plurality of video signal lines, and
a scanning signal driving circuit inputting the scanning signal to each of the plurality of scanning signal lines and turning on the switching elements belonging to a group of the pixels corresponding to the each of the scanning signal lines, wherein
the scanning signal driving circuit has a decoder varying an output voltage of the scanning signal from the scanning signal driving circuit, the output voltage of the scanning signal decreases as the scanning signal line to which the scanning signal is applied is located closer to the video signal driving circuit.

12. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface, each of which has a switching element and receives a video signal from one of the plurality of video signal lines in response to an application of a scanning signal to the switching element by one of the plurality of scanning signal lines;
a scanning signal driving circuit outputting the scanning signal to each one end of the plurality of scanning signal lines, and
a plurality of video signal driving circuits juxtaposed along at least one of the plurality of scanning signal lines, each of the plurality of video signal driving circuits outputs the video signal to each of a group of the plurality of video signal lines corresponding to the each of the plurality of video signal driving circuits, and wherein
the video signal has a voltage in accordance with a tone to be displayed, the voltage is determined by and varies in accordance with a gradation forming voltage, and
the gradation forming voltage at when one of the plurality of video signal driving circuits outputs the video signal is dropped in comparison with the gradation forming voltage at when another of the plurality of video signal driving circuits located further from the scanning signal line than the one of the plurality of video signal driving circuits outputs the video signal.

13. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface; and
a plurality of pixels arranged two-dimensionally on the substrate surface, each of which has a switching element and receives a video signal from one of the plurality of video signal lines in response to an application of a scanning signal to the switching element by one of the plurality of scanning signal lines;
a scanning signal driving circuit outputting the scanning signal to each one end of the plurality of scanning signal lines; and
at least one video signal driving circuit outputting the video signal to each one end of the plurality of video signal lines, wherein
an output of the video signal to respective one of the video signal lines is delayed sequentially as far from the scanning signal driving circuit as the respective one of the video signal lines is located.

14. A display device comprising:
a plurality of scanning signal lines juxtaposed on a substrate surface;
a plurality of video signal lines juxtaposed transverse to the plurality of gate signal lines;
a plurality of pixels arranged two-dimensionally on the substrate surface to form a display area, each of the pixels has a switching element and receives a video signal from one of the plurality of video signal lines in response to an application of a scanning signal to the switching element by one of the plurality of scanning signal lines;
an operation means to which display data are inputted; and
a video signal driving circuit outputting the video signal to each of the plurality of video signal lines on the basis of an output of the operation means, wherein
the operation means receives information related to brightness inclination in the display area, detects a portion of the display area where the brightness inclination might appear and a minimum brightness level or a brightness level closer to the minimum brightness level in the portion thereof with reference to the information, and outputs a correction data decreasing the brightness of the display data in another portion thereof without a possibility of the brightness inclination and increasing the brightness of the display data in the portion thereof having a possibility of the brightness inclination to compensate its brightness decrease with reference to the minimum brightness level or the brightness level closer to the minimum brightness level to the video signal driving circuit.

15. A display device according to claim 14, wherein
the operation means divides brightness range from a zero tone to another tone corresponding to the minimum brightness level or the brightness level closer to the minimum brightness level into a larger number of tones than a number of tones counted up from the zero tone to the another tone, and generates the correction data corresponding to the larger number of tones.
